(19) United States
(12) Patent Application Publication
(10) Pub. No.: US 2020/0263580 A1
(43) Pub. Date: Aug. 20, 2020

(54) Method and Device Intended to Purify Sulphur Oxide Containing Exhaust Gas from Internal Combustion Engines by Means of a Multi-stage Adsorption Method

(71) Applicant: Primarine GmbH, Buchholz i.d.N. (DE)

(72) Inventor: Ralf Jürgens, Henstedt-Ulzburg (DE)

(21) Appl. No.: 16/789,624

(22) Filed: Feb. 13, 2020

(30) Foreign Application Priority Data
Feb. 14, 2019 (DE) 10 2019 103 741.7

(51) Int. Cl. F01N 3/08; B01D 53/04; F01N 13/00; B01J 20/04; B01J 20/20; B01J 20/28

(52) U.S. Cl. CPC F01N 3/085; B01D 2259/4566; F01N 3/0885; F01N 13/0093; F01N 13/004; F01N 3/0878; B01J 20/041; B01J 20/043; B01J 20/20; B01J 20/2803; B01J 20/28004; B01D 2253/10; B01D 2257/302; B01D 2259/128; B01D 2253/1124; B01D 2253/102; B01D 2259/40005; B01D 2259/40084; B01D 2259/402; B01D 53/04

(57) ABSTRACT

A method and a device intended to purify pollutants from an exhaust gas flow of an internal combustion engine operated with sulphur containing fuel, in particular of a ship internal combustion engine operated with heavy fuel oil, are provided. Exhaust gas flow is in contact with a solid adsorption agent of the adsorber in a first step and binding in particular acid pollutants, which comprise sulphur dioxide and sulphur trioxide. The exhaust gas flow is then guided by a second stage of the adsorber realising fine purification of the exhaust gas flow. The adsorption agent of the second stage is used in the first stage as an adsorption agent.

### BACKGROUND

The present invention relates to a method and a device intended to purify pollutants from an exhaust gas flow of an internal combustion engine operated with sulphur containing fuel, in particular of a ship internal combustion engine operated with heavy fuel oil. This internal combustion engine can also be a high-pressure loaded internal combustion engine. Hereinafter, reference is mostly made to internal combustion engines without this being intended to be limitative.

In the prior art, internal combustion engines are equipped with various exhaust gas post-treatment systems intended to reduce discharges of pollutants. The essential pollutants from exhaust gas derived from internal combustion engines operated on board of ships are nitrogen oxides (NOₓ), sulphur dioxide (SO₂), sulphur trioxide (SO₃), carbon monoxide (CO), carbon dioxide (CO₂), unburned hydrocarbons (HC), such as paraffins, aldehydes, olefins, aromates, such as carbon black particles, containing carbon both as solids as in the shape of so-called “Volatile Organic Compounds” (VOC). Moreover, the latter also include fine dust particles known as “PM2.5” and “PM10”, depending on their particle size. Furthermore, the latter also include heavy metals, such as vanadium, nickel, lead, zinc, and cadmium as well as aluminium, magnesium, cobalt, and silicon.

The ship internal combustion engines are slowly rotating 2-stroke-engines operated with heavy fuel oils of the categories IFO 180 (Intermediate Fuel Oil), IFO 380, MDO (Marine Diesel Oil), and MGO (Marine Gas Oil). Such ship internal combustion engines can also be configured as 4-stroke-engines operated with the same heavy fuel oils. Nowadays, fuels for passenger cars and lorries contain sulphur contents from 10 ppm to 50 ppm, while fuels for ship internal combustion engines, such as Heavy Fuel Oil (HFO), can usually have a fraction or organic bound sulphur which can come to a factor of up to 1,000 and above and attain 4.5 per cent by volume. Moreover, heavy fuel oils used in ship engines contain large fractions of heavy metal in a milligram range per litre of fuel.

Approximately 90% of the entire worldwide freight volume is transported by ship driven by big motors fed by residual oils. Over 350 million tons of motor fuels are thereby combusted, resulting into emissions in the shape of sulphur dioxides, nitrogen oxides, and particles. The issue is to reduce and to minimize such damage to the environment.

In October 2008, the International Maritime Organization amended Appendix VI of the MARPOL Convention in order to reduce these very emissions (MARPOL=International Convention for the Prevention of Marine Pollution from Ships). The focus here was laid on nitrogen oxides (NOₓ), sulphur oxides (SOₓ), and particles (PM). The EU directive 2005/33 in effect as of Jan. 1, 2010, specifies for any and all ships manoeuvring for more than two hours in the harbour or being at the pier, to use fuel containing less than 0.1% sulphur. Such maximum permissible value was also introduced as of Jan. 1, 2020 by the California Air Resources Board (CARE) in the Californian harbours and was extended to a 24-mile zone in 2012.

All such regulations (MARPOL Appendix VI, EU Directive 2005/33, CARB 1, and CARB 2) also allow the operation of exhaust gas treatment equipment on board as an alternative to the use of sulphur reducing fuel, provided such equipment is able to attain an emissions equivalence value corresponding to the use of sulphur reduced fuel.

Pollutants are generated during the combustion process or in the exhaust gas flow when combusting fossil fuels. The HFO (Heavy Fuel Oil) fuel used in ship engines is a residual product from the raffinate process of the petroleum industry and, depending on its origin, contains various amounts of sulphur, vanadium, cadmium, lead, and other heavy metals. Their sulphur content varies significantly depending on the country of origin. For the time being, the average sulphur content of the fuels used on a worldwide basis comes to approximately 2.7 per cent by weight. During the combustion process inside the engine, sulphur bound to various carbons reacts with oxygen to become SO₂ (approxim. 95%) and SO₃ (approxim. 5%).

Furthermore, highly concentrated nitrogen oxides (NO and NO₂) are generated during the combustion process. Other than onshore, where emission limit values were determined for the most various emission sources, such as coal-fired power plants, waste incineration plants, steel mills and cements plants, but also for passenger cars and lorries, many years ago already, the maximum permissible values for navigation purposes were adopted more recently only. During the MEPC 58 (Marine Environment Protection Committee) in October 2008, stepwise reduction of sulphur contents in fuels was adopted as a resolution in the EPC.176. As an alternative, operation of exhaust gas post-treatment equipment is authorised.

Various exhaust gas post-treatment methods intended to purify exhaust gas from internal combustion engines on board of ships are already used. Document WO 2009/149603 A, as well as CN 000102371101A and document WO 2007/054615 A propose an exhaust washing process. All such processes use sea water in order to purge Soxₓ emissions. Document WO 2010/026018 A proposes a dry desulphurisation method using granules made of calcium hydroxide intended for desulphurisation purposes and to be carried along on board. Document DE 10 2010 017 5632 A1 describes a multi-stage method where every stage provides a discrete reactor unit and therefore consisting of several, reactors arranged one after the other which can also be operated independently from each other.

A drawback of the aforementioned methods is that these show an exponential increase in excess of 95% of the sorption agent consumption in the presence of significant elimination rates and that construction volume and weight also exponentially increase in the presence of sulphur contents in excess of 2% m/m (mass fraction of the mixture constituents) in the fuel, such that these methods cannot be used efficiently on board of a ship for reasons of space and costs.

Therefore, an object of the invention is a create an exhaust gas post-treatment method intended to purify exhaust gas from ship internal combustion engines which can be operated on board of a ship and enabling to comply with the required emission limit values.

According to the invention, this object is provided by the exhaust gas flow being in contact with a solid adsorption agent of the adsorber, binding in particular acid pollutants, which comprise sulphur dioxide and sulphur trioxide, and where the exhaust gas flow is then guided through a second stage of the adsorber realising fine purification of the exhaust gas flow and where the adsorption agent of the second stage is used in the first stage as adsorption agent. This method enables to comply with the required emission limit values even in the presence of significant SOₓ concentrations while using little adsorption agent amounts efficiently. In a first step, the adsorption agent is heavily loaded with pollutants, whereas fine purification with adsorption agent still unloaded is carried out in the second step, which enables to comply with the required emission limit value.

Hereinabove, the main issue discussed dealt with adsorption. In reality, the issue here is adsorption and absorption. The granule-shaped adsorption agent shows a pore structure made of micro, meso and macro pores where adsorption takes place in a first step. Inside said granules, adsorption is taking place instead. Therefore, it is hereinafter referred to adsorption, also including absorption within the granules.

The prior art of flue gas purification also includes various adsorbers and absorber embodiments, such as fixed-bed adsorbers, moving-bed adsorbers, or turbulent fluidised-bed adsorbers. In view of the flow direction of the flue gas, said adsorber embodiments are operated as cross flow reactors, transverse flow reactors, or counter-flow reactors. The adsorber used herein can be embodied as a transverse flow reactor. The adsorption agent used is composed of granules containing various per cent by weight of calcium hydroxide, calcium carbonate and/or sodium hydrogen carbonate. The adsorption agent can flow through the adsorber as moving layer with continuous or discontinuous discharge. The granule shaped adsorption agent can have a cubic or spherical or a chip-like shape having a grain size between 1.0 mm and 15.0 mm and preferably between 2.0 and 10.00 mm and in particular between 2.0 and 6.0 mm.

Moreover, it can be provided that the solid adsorber contains a carbon containing addition agent, in particular active charcoal and/or hearth-coke, in particular having a fraction from 0.1 per cent by weight to 50 per cent by weight, preferably from 1.0 per cent by weight to 35 per cent by weight. Purification of exhaust gas is thereby fostered further on. By means of chemical reaction (chemical sorption) taking place in the adsorber, acid exhaust gas and in particular nitrogen oxides are bound and transformed into less toxic products.

The fresh and unloaded granules are extracted into the adsorber from a storing silo not detailed herein and, having flown through the adsorber, collected and temporarily stored in a residual material silo which is not described in detail herein. The adsorbing agent can be removed in harbour from the temporary store.

It is preferred that the exhaust gas flow has a temperature between 150° C. and 450° C. when entering into the first stage of the adsorber. Here, chemical adsorption takes place under advantageous conditions.

Said adsorption agent can be guided continuously first via the second and then via the first stage of the adsorber. It is also possible for said adsorption agent to be guided discontinuously first via the second and then via the first stage of the adsorber. In both cases this achieves that unloaded and fresh adsorption agent will be available for chemical sorption in the second stage for exhaust gas fine purification purposes. In the first stage, said adsorption agent which was only slightly loaded in the second stage, is used to pre-purify said exhaust gas.

In the event of discontinuous feed of the adsorber, it can be provided that, during renewal of granules, an amount of unloaded granules is fed to the second stage which correspond at least to the amount of granules of the first stage. It can be provided that the same amounts of adsorption agents are present in the first and the second stage. Thereby, it is achieved that the same amount of the slightly loaded adsorption agent is guided into the first stage for pre-purification purposes, where it will then be loaded further on. This ensures in particular that no granules be loaded only slightly. Thereby, adsorption agent consumption can be kept to a minimum.

Residence time of said granules in the adsorber can be adjusted in the adsorber by means of the extraction amount and the extraction speed of the extraction members. Rotary gate valves can be inserted here.

Said purification device of pollutants coming from the exhaust gas flow presents an exhaust gas pipe which the exhaust gas from the internal combustion engine flows through. It is provided that at least one shut-off valve is arranged inside the exhaust gas pipe, that the exhaust gas cladding is perforated in a first region in the flow direction upstream said shut-off valve, thereby forming a first adsorption stage, and in a second region in the flow direction downstream said shut-off valve while forming a second adsorption stage, that said perforated regions are covered by a continuous adsorption agent channel and that said adsorption agent channel is covered by a flow channel the interior cladding of which, confining said absorption agent channel, is perforated. A flow path is thereby provided for said exhaust gas such that this exhaust gas, with the shut-off valve closed, is guided outside through said perforation in the first region via the adsorption agent channel into the flow channel and therefrom inside, through the adsorption agent channel and through said perforation in the second region, back into the exhaust gas pipe in flow direction downstream said shut-off valve. The adsorption channel is filled with said adsorption agent. An exhaust gas forced flow passing through the adsorption agent is generated such that purification of said exhaust gas can take place.

Here, said exhaust gas pipe of the device of the invention is generally the exhaust gas pipe already provided in the internal combustion engine and which was machined accordingly. Therefore, said device can also be mounted later on. But it can also be provided that a pipe portion prepared accordingly is mounted into the ship already when mounting the exhaust gas pipe.

It can furthermore be provided that said exhaust gas pipe is not perforated in the shut-off valve region between the first and the second stage. Fundamentally, the first and second stage can also be connected directly one after the other. By providing a non-perforated region between the first and the second stage, however, short circuit currents are avoided.

Moreover, it can be provided that the exterior cladding of the absorption agent channel which corresponds to the interior cladding of the flow channel is not perforated in the region corresponding to the non-perforated region of the exhaust gas pipe, either. Hereby, too, the desired exhaust gas flow is facilitated by the two adsorber stages thereby separated and spaced apart.

According to a preferred embodiment it is provided that the first and the second exhaust gas pipe regions are perforated alongside its circumference and in axial direction and that the adsorption agent channel and the flow channel surround both regions as a jacket. Hence, said adsorber surrounds said exhaust gas pipe as a collar, resulting into a space-saving exhaust gas post-treatment structure.

In particular, it can be provided that both regions and said shut-off valve are arranged in a portion extending vertically of said exhaust gas pipe and that said absorption agent channel is fillable from the top with an adsorption agent and has at least one extraction member intended for the used-up adsorption agent on its lower face such that the adsorption agent is transported through said adsorption agent channel due to gravity. Owing to such arrangement, it is possible to do without any means of conveyance of said adsorption agent through the adsorption channel. As a rule, said internal combustion engine is arranged in the lower part of the ship, in particular in a ship. Hence, said exhaust gas pipe extends from the bottom to the top through the entire hull such that sufficient space is provided at various spots for collar-shaped adsorption devices.

Furthermore, it can be provided that the volumes of the adsorption channel surrounding the first and the second regions of the adsorption channel fundamentally have the same size. Thereby, it is achieved that the same amount of adsorption agents is present in the first and the second stages so formed.

Said discharge member at the lower end of said adsorption channel can be embodied as rotary gate valve. This type of material discharge work has proven of value.

According to another embodiment of the invention, two shut-off valves which can be opened by forming a bypass, are provided in flow direction between the first and the second regions. This enables to maintain operation of the ship even where the adsorption channel should be congested, for example. Said ship can then also be operated without any exhaust gas post-treatment, for example when combusting a low-emission fuel or on the high seas.

The proposed embodiment of said adsorber is space-saving and therefore can advantageously be used for an exhaust post-treatment equipment in ships offering limited space capacities only. Another advantage consists in such an adsorber arrangement being adapted for integration into a ship even later on. Only a sufficiently long, free exhaust gas pipe length alongside which the adsorber of the invention can be mounted is required. As always, only a relatively small amount of adsorption agent is contained in said adsorption channel, the ship's stability and trimming are not impaired.

By providing lockable shut-off valves inside said exhaust gas pipe it is possible to release exhaust gas coming from the engine even in a non-purified condition, e. g. where a low-emission fuel is combusted and where no desulphurisation or denitrogenation is required. Said bypass also allows to avoid any impairment of engine performance in the event of unacceptable increase in exhaust gas counter-pressure in the adsorber.

### BRIEF DESCRIPTION OF THE DRAWINGS

Hereinafter, the invention will be explained in more detail by means of the schematic drawings. In these drawings:

FIG. 1 shows the longitudinal section of an exhaust gas pipe with an adsorber of the invention and

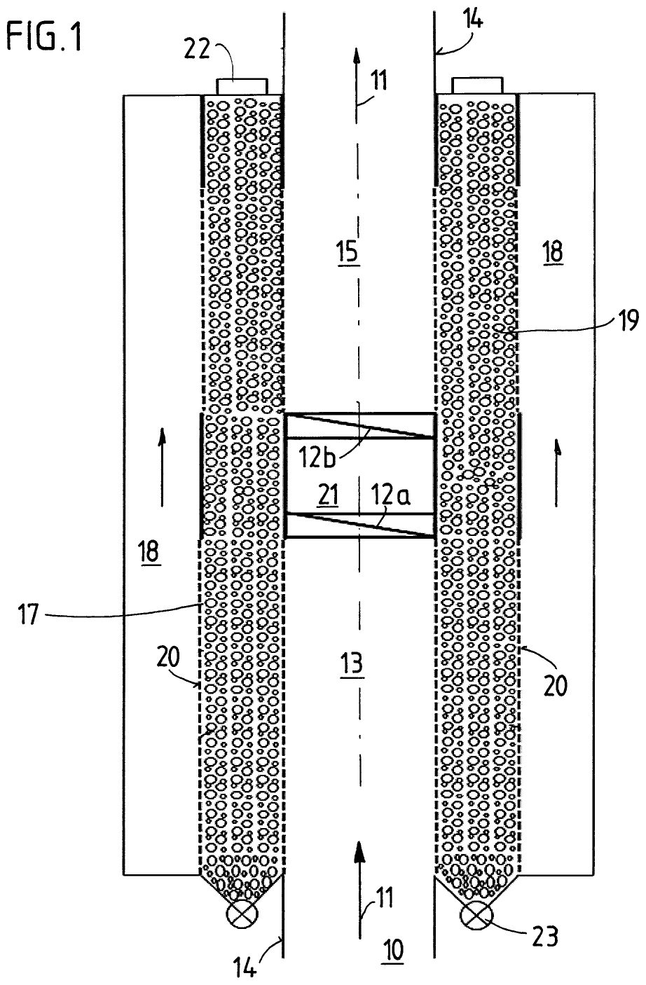

FIG. 2 shows the exhaust gas flow extending through the absorber of the invention.

### DETAILED DESCRIPTION

The exhaust gas equipment shown in the drawing comprises an exhaust gas pipe 10 through which exhaust gas generated in the internal combustion equipment, not shown, flows in the main flow direction 11. Said exhaust gas pipe 10 extends at least in a portion vertically, for example through a hull, not shown, either.

Two shut-off valves 12a, b enabling shut-off of said exhaust gas pipe and arranged one after the other, are provided in said exhaust gas pipe 10 in flow direction 11. The cladding 14 of the exhaust gas pipe in a region 13 arranged in flow direction upstream the front shut-off valves 12a are embodied as perforated walls. The local cladding of the exhaust gas pipe 10 in a second region 15 arranged in flow direction 11 downstream the rear shut-off valves 12b is embodied as perforated cladding. Said perforations extend across a determined length of the exhaust gas pipe in flow direction 11 and around the entire total circumference of the exhaust gas pipe in the first and the second regions.

Both regions 13, 15 arranged one after the other in flow direction are surrounded by a jacket-shaped adsorption channel 17. Said adsorption channel 17 is in turn surrounded by a flow channel 18 having an annular cross section. In detail, said arrangement is embodied such that said adsorption channel 17 is permeable from the top to the bottom and filled with a granule-shaped adsorption agent 19. Said cladding 20 between the adsorption channel 17 and said exterior flow channel 18 is perforated in the regions extending alongside the circumference and facing the first and the second regions 13, 15. The claddings in the zone 21 wherein the shut-off valves 12a, b are arranged, are not perforated.

This arrangement provides a two-stage adsorber by simple means. Exhaust gas flows through said exhaust gas pipe 10 and is guided through said adsorption channel 17, said shut-off valves 12a, b being closed. Said adsorption agent is flown through transversally relative to the flow direction. Then, the exhaust gas arrives through the perforation in the exterior cladding 20 of said adsorption channel 17 into said flow channel 18 and flows through perforation arranged further downstream in flow direction 11, passing trough said fresh adsorption agent 19 arranged further upstream, back into the exhaust gas pipe in flow direction downstream the rear shut-off valve 12b. Thus, the first region 13 upstream the first shut-off valve 12a forms a first adsorption stage while the second region 15 downstream the second shut-off valve 12b forms a second adsorption stage.

Said adsorption agent is fed in said adsorption channel 17 having an annular cross section via feed openings 22 at the upper end of the latter. Due to gravity, it migrates downwards and is removed from the adsorption channel 17 at the lower end via discharge members 23 which can be embodied as rotary gate valves. In the upper region, directly upstream said feed opening 22, said adsorption channel 17 cannot be perforated alongside the circumference and hence be embodied in a closed manner in order to prevent any flow through the feed-in region of exhaust gas.

The hole size of the perforated portions of the corresponding claddings 14, 20 is dimensioned such that said granule-shaped adsorption agent 19 is safely maintained in the adsorption channel. For example, a hole size from 1.0 mm to 3.0 mm can be provided.

Hence, said adsorption agent 19 continuously or discontinuously migrates through said adsorption channel from the top to the bottom, while said exhaust gas flows through said adsorption agent 19, in a first step, from the bottom in the first region 13 and then in the upper, second region 15. This enables to reach a two-stage embodiment of the adsorber, where exhaust gas pre-purification takes place in the first stage 13 arranged in flow direction and exhaust gas fine purification takes place in the second region 15, downstream in flow direction. Such arrangement is extremely space-saving and can be integrated into ship structures, even later on.

For example, filling of the adsorber with said adsorption agent can be carried out by means of a pneumatic conveyor device, not shown, also enabling exhaustion of said absorber.

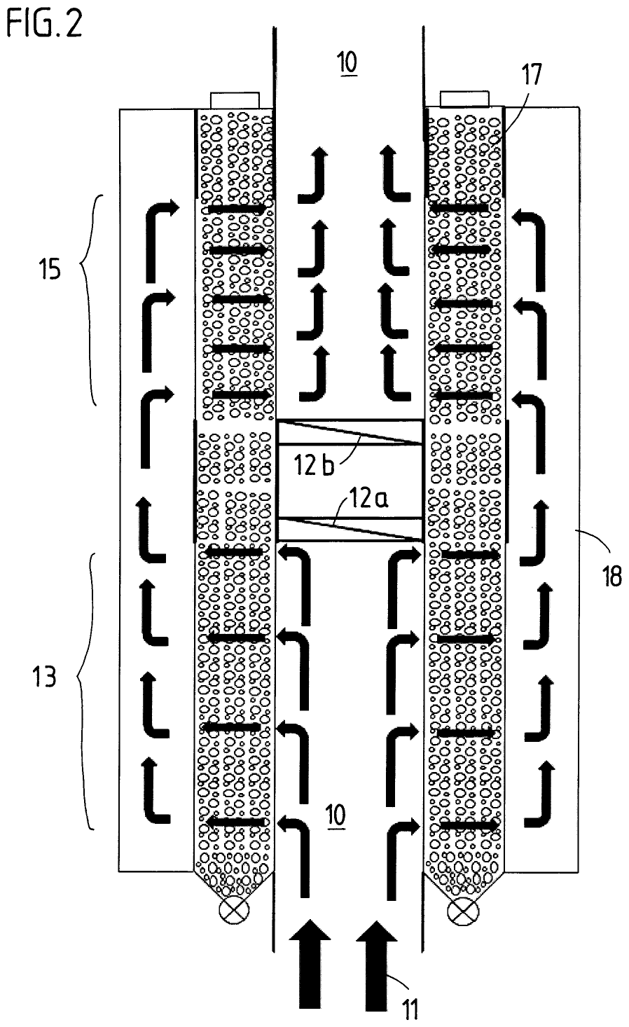

Altogether, this results into the exhaust gas flow pattern schematically shown in FIG. 2. In the event of a too important pressure rise in the adsorber channel 17, said shut-off valves 12a, b can be opened partially or totally. Then, said exhaust gas is dispensed into the environment following no or partial purification only. Depending on the fuel type used, said shut-off valves 12a, b can also be opened or closed. Such tasks can be realised simply and readily by the staff on board and can be adapted to the respective fuel type used.

Due to the two-stage method, the granule-shaped adsorption agent is almost entirely loaded with pollutants. To this end, fresh and unloaded adsorption agent is always available for said fine purification such that the desired emission guide values can be complied with. Only saturated adsorption agent is exhausted at the adsorption channel 17 exit, thereby resulting into economical consumption. Therefore, adsorption agent quantities to be taken along with can be kept to a minimum.

1. A purification method of pollutants from an exhaust gas flow of an internal combustion engine operated with sulphur containing fuel, in particular a ship internal combustion engine operated with heavy fuel oil, characterised in that said exhaust gas flow being in contact with a solid adsorption agent (19) of the adsorber in a first stage (13), binding in particular acid pollutants, which comprise sulphur dioxide and sulphur trioxide, and where the exhaust gas flow is then guided by a second stage (15) of the adsorber realising fine purification of the exhaust gas flow and where the adsorption agent of the second stage (15) is used in the first stage (13) as adsorption agent.

2. The method according claim 1, wherein said adsorption agent (19) used is composed of granules containing calcium hydroxide and/or calcium carbonate, sodium carbonate and/or sodium hydrogen carbonate and/or magnesium oxide and/or magnesium hydroxide.

3. The method according to claim 1, wherein said solid absorbing agent (19) is available in the shape of granulated bulk material, having in particular a grain size between 1 mmm and 20 mm and preferably between 2 mm and 8 mm.

4. The method according to claim 1, wherein the solid adsorber (19) contains a carbon containing addition agent, in particular active charcoal and/or hearth-coke, in particular having a fraction from 0.1 per cent by weight to 50 per cent by weight, preferably from 1 per cent by weight to 35 per cent by weight.

5. The method according to claim 1, wherein the exhaust gas flow has a temperature between 150° C. and 450 ° C. when entering into the first stage of the adsorber.

6. The method according to claim 1, wherein said adsorption agent is guided continuously first via the second and then via the first stage of the adsorber.

7. The method according to claim 1, wherein said adsorption agent (19) is guided discontinuously first via the second and then via the first stage of the adsorber.

8. The method according to claim 7, wherein, during renewal of granules, an amount of unloaded granules is fed to the second stage and which correspond at least to the amount of granules of the first stage.

9. The method according to claim 1, wherein the same amounts of absorption agent are available in the first and the second stages.

10. The method according to claim 1, wherein the residence time of said granules in the absorber can be adjusted in the adsorber by means of the discharge amount and the discharge speed of the discharge members.

11. A purification device of pollutants coming from an exhaust gas flow of an internal combustion engine operated with a sulphur containing fuel, in particular with a ship internal combustion engine operated with heavy fuel oil, where said internal combustion engine has at least one exhaust pipe (10), which is flown through by said exhaust gas, comprising at least one shut-off valve (12a, 12b) available in said exhaust gas pipe (10), wherein exhaust gas cladding (14) is perforated in a first region (13) in flow direction (11) upstream said shut-off valve (12a), thereby forming a first adsorption stage, and a second region (15) in flow direction (11) downstream said shut-off valve (12b), thereby forming a second adsorption stage, wherein said perforated regions are covered by a continuous adsorption channel (17), wherein said adsorption channel (17) is covered by a flow channel (18), the interior cladding (20) of which limits said cladding (20) and is perforated such that, with the shut-off valve (12a, 12b) closed, said exhaust gas is guided outside through said perforation in the first region (13), passing by said adsorption channel (17) in said flow channel (18) and therefrom inside through said adsorption channel (17) and through said perforation in the second region (15), back into said exhaust gas pipe (10) in said flow direction (11) downstream said shut-off valve (12b).

12. The device according to claim 11, wherein said exhaust gas pipe (10) is not perforated in a shut-off valve (12a, 12b) zone (21) between the first and the second stage.

13. The device according to claim 11, wherein the exterior cladding (20) of the adsorption agent channel (17) is not perforated in the region corresponding to the non-perforated zone (21) of the exhaust gas pipe (10).

14. The device according to claim 11, wherein the first and the second exhaust gas pipe (10) regions are perforated alongside its circumference and in axial direction and that the adsorption agent channel (17) and the flow channel (18) surround both regions as a jacket.

15. The device according to claim 11, wherein both regions (13, 15) and said shut-off valve (12a, 12b) are arranged in a vertically extending portion of said exhaust gas pipe (10) and wherein said absorption agent channel (17) is Tillable from the top with an adsorption agent (19) and has at least one extraction member (23) intended for the used-up adsorption agent on its lower face such that the adsorption agent (19) is transported through said adsorption agent channel (17) due to gravity.

16. The device according to claim 11, wherein the first and second regions of the volumes of the adsorption channel (17) surrounding said exhaust gas pipe (10) fundamentally have the same size.

17. The device according to claim 11, wherein said extraction member is embodied as a rotary gate valve.

18. A device according to claim 11, wherein two shut-off valves (12a, 12b) which can be opened by forming a bypass, are provided in flow direction between the first and the second regions.
